(19) United States
(12) Patent Application Publication
(10) Pub. No.: US 2016/0351922 A1
(43) Pub. Date: Dec. 1, 2016

(54) BURNER

(71) Applicants: Toshiba Fuel Cell Power Systems Corporation, Yokohama-shi (JP); Futaba Industrial Co., Ltd., Okazaki-shi (JP)

(72) Inventors: Tomoyuki SUZUKI, Okazaki (JP); Koichi KAWAMOTO, Yokohama (JP); Masatoshi TANAKA, Tokyo (JP)

(73) Assignees: Toshiba Fuel Cell Power Systems Corporation, Yokohama-shi (JP); Futaba Industrial Co., Ltd., Okazaki-shi (JP)

(21) Appl. No.: 15/237,116

(22) Filed: Aug. 15, 2016

Related U.S. Application Data
(63) Continuation of application No. PCT/JP2014/054658, filed on Feb. 26, 2014.

(51) Int. Cl. H01M 8/04014; H01M 8/0612; F23D 14/22

(52) U.S. Cl. CPC H01M 8/04022; F23D 14/22; H01M 8/0618

(57) ABSTRACT

According to one embodiment, there is provided a burner includes a nozzle member formed with a first penetration hole through which the ignition means can penetrate, a downstream side nozzle fixing unit formed with a second penetration hole through which the nozzle member can penetrate, wherein the first penetration hole is coaxial with the second penetration hole, and an upstream side nozzle fixing unit formed with a third penetration hole through which the ignition means can penetrate, wherein the third penetration hole is coaxial with the second penetration hole, and the ignition means is coaxial with the third penetration hole.

### CROSS-REFERENCE TO RELATED APPLICATIONS

This application is a Continuation application of PCT Application No. PCT/JP2014/054658, filed Feb. 26, 2014, the entire contents of all of which are incorporated herein by reference.

### FIELD

Embodiments described herein relate to a burner.

### BACKGROUND

A fuel processing system used for a fuel cell electric power system and the like obtains gas including hydrogen gas (reformed gas) from fuel including a hydrogen component (reformer fuel) such as, e.g., city gas having methane as its main component. The reforming reaction used to obtain the reformed gas from the reformer fuel is an endothermic reaction. Therefore, in general, a flame generated by ignition means such as a burner, an ignition plug, and the like is used to heat the reformer fuel with the heat of the flame so as to stably perform the reforming reaction.

For example, as illustrated in Patent Literature 1 and Patent Literature 2, the fuel processing system includes a container filled with catalyst and a burner igniting mixed gas including fuel gas and air with an ignition plug.

This type of burner includes a first partition wall, a second partition wall, and a third partition wall. The first partition wall is disposed in a concentric circle manner about the ignition plug, and is disposed at the external peripheral side of the ignition plug. The second partition wall is disposed in a concentric circle manner about the first partition wall, and is disposed at the external peripheral side of the first partition wall. The third partition wall is disposed in a concentric circle manner about the second partition wall, and is disposed at the external peripheral side of the second partition wall.

In the burner configured as described above, a first air flow channel is formed between the ignition plug and the first partition wall to allow air to flow therethrough, and a fuel gas flow channel is formed between the first partition wall and the second partition wall to allow fuel gas to flow therethrough, and a second air flow channel is formed between the second partition wall and the third partition wall to allow air to flow therethrough. The first partition wall, the second partition wall, and the third partition wall are disposed as described above, and the first air flow channel, the fuel flow channel, and the second air flow channel are formed in a concentric circle manner, such that the air and the fuel gas are provided to a burner chamber.

### PRIOR ART REFERENCE

### Patent Literature

[Patent Literature 1]

Jpn. Pat. Appln. KOKAI Publication No. 2012-101969

[Patent Literature 2]

Jpn. Pat. Appln. KOKAI Publication No. 2004-182489

### SUMMARY

### Technical Problem

According to the above configuration, when a nozzle member is disposed with a deviation from a predetermined position with respect to a nozzle fixing member serving as a base for fixing a nozzle member (first partition wall), and the amount of air flowing through the air flow channel deviates in the peripheral direction, which may make the combustion unstable, and because of the same reason, it used to be necessary to employ a rigid design such that the seal of the partition wall is not broken by thermal stress and the like.

It is an object of an aspect of the present invention to provide a burner capable of accurately providing a burner unit at a predetermined position with respect to a reformer unit of a conventional fuel processing system.

### Solution to Problem

An aspect of the present invention relates to a burner, which is provided with stick shaped ignition means disposed to penetrate through a part of the burner to ignite a mixed gas including air and fuel gas, and which is formed with an air flow channel in which the air flows and a fuel gas flow channel in which the fuel gas flows.

The burner comprises: a nozzle member formed with a first penetration hole through which the ignition means can penetrate, and formed on a downstream side of the air flow channel and a downstream side of the fuel gas flow channel; a downstream side nozzle fixing unit which fixes the nozzle member and which is formed with a second penetration hole through which the nozzle member can penetrate and on an upstream side of the fuel gas flow channel, wherein the nozzle member is disposed in the second penetration hole such that the first penetration hole is coaxial with the second penetration hole; and an upstream side nozzle fixing unit which fixes the nozzle member and which is formed with a third penetration hole through which the ignition means can penetrate and on an upstream side of the air flow channel, wherein the upstream side nozzle fixing unit is disposed on the downstream side nozzle fixing unit such that the third penetration hole is coaxial with the second penetration hole, and the ignition means disposed in the third penetration hole such that the ignition means is coaxial with the third penetration hole.

### Advantages of the Invention

According to an aspect of the present invention, the nozzle member is disposed in the downstream side nozzle fixing unit such that the first penetration hole is coaxial with the second penetration hole. The third penetration hole is disposed in the downstream side nozzle fixing unit such that the second penetration hole is coaxial with the third penetration hole. The ignition means is disposed in the upstream side nozzle fixing unit such that the ignition means is coaxial with the third penetration hole.

Accordingly, the nozzle member can be accurately disposed at a predetermined position with respect to the member for fixing the nozzle member, i.e., the downstream side nozzle fixing unit, and further, the ignition means can be accurately disposed at a predetermined position with respect to the downstream side nozzle fixing unit by using the upstream side nozzle fixing unit.

### BRIEF DESCRIPTION OF THE DRAWINGS

FIG. 1 is an exploded perspective view of a burner illustrating an embodiment of the present invention.

FIG. 2 is a perspective view of a burner illustrating an embodiment of the present invention.

FIG. 3 is a side view of a burner.

FIG. 4 is a cross sectional view of a burner illustrating a first embodiment of the present invention.

FIG. 5 is an example of a fuel processing system having a burner embedded therein illustrating the first embodiment of the present invention.

FIG. 6 is a cross sectional view of a burner illustrating a second embodiment of the present invention.

### DETAILED DESCRIPTION

An embodiment of the present invention will be explained with reference to the drawings. For the sake of explanation, a side provided with a burner with respect to a reformer unit of a fuel processing system is defined as an upper side in the explanation.

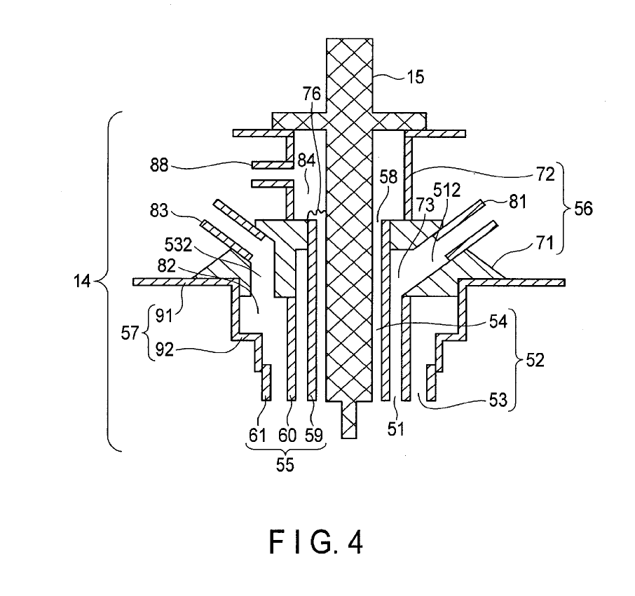

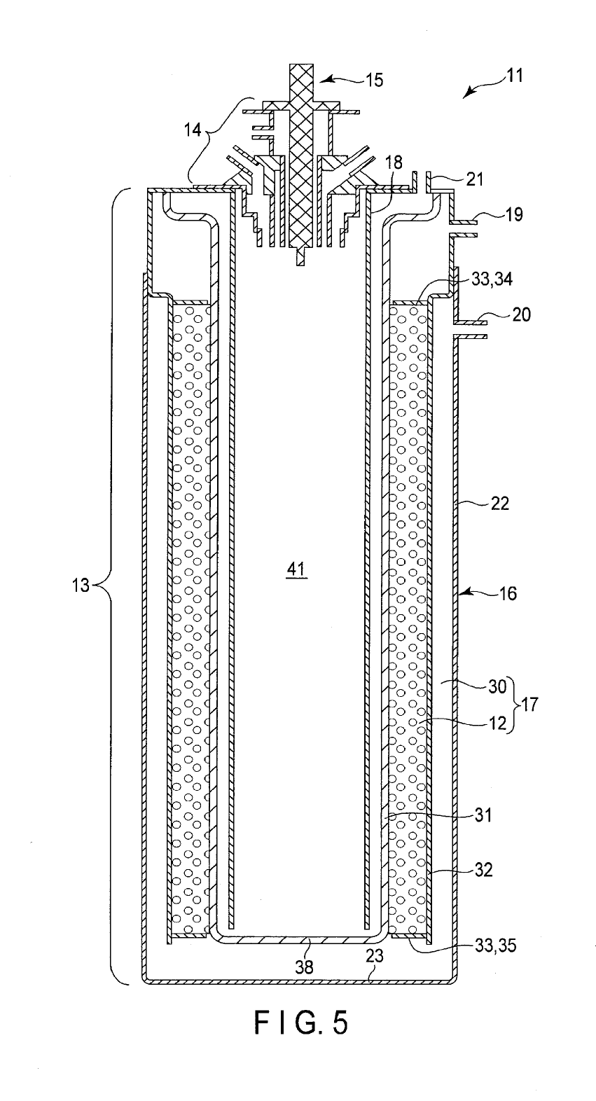

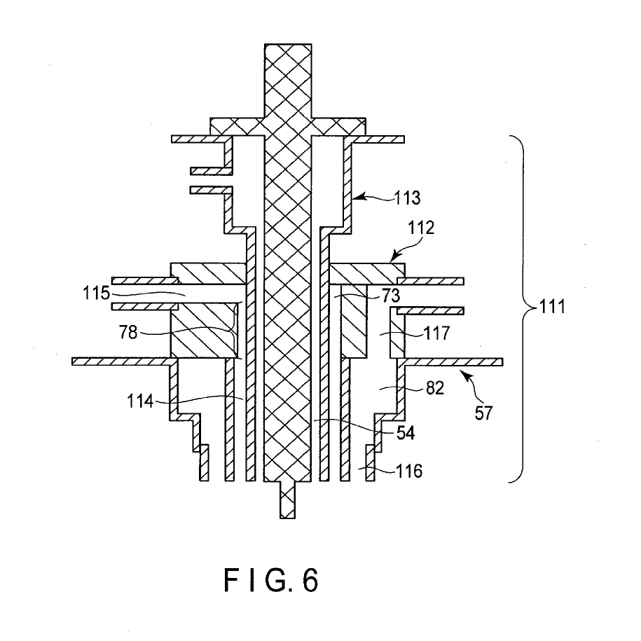

The cross sectional views of the burner in FIG. 4, FIG. 5 and FIG. 6 schematically illustrate a fuel gas channel, a flow channel, and an air flow channel in order to describe these flow channels.

### First Embodiment

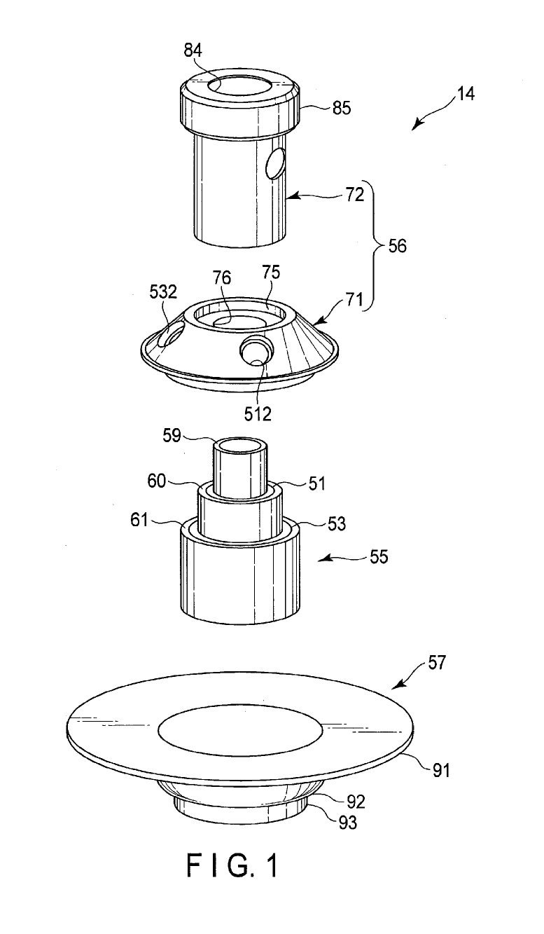

The first embodiment will be explained with reference to FIG. 1 to FIG. 5.

### <Configuration of Fuel Processing System>

For example, a fuel processing system 11 as illustrated in FIG. 5 generates hydrogen gas provided to a fuel cell in a fuel cell electric power system, not shown, and causes a fuel including hydrogen component such as city gas including methane as a main component (hereinafter referred to as a reformer fuel) to be in contact with a catalyst 12 and obtains a gas including the hydrogen gas (hereinafter referred to as a reformed gas).

Like a conventional device, the fuel processing system 11 includes a reformer unit 13, a burner 14, and ignition means 15 for igniting a mixed gas explained later.

### <Configuration of Reformer Unit>

The reformer unit 13 is in a container shape accommodating the catalyst 12, a lower end portion of the burner 14, and a lower end portion of the ignition means 15. An upper side of the reformer unit 13 is open. The reformer unit 13 includes a housing 16, a main chamber of reformer 17, burner chamber forming components 18, a reformer fuel supply tube 19, a reformed gas outlet tube 20, and a combustion gas discharge tube 21.

An upper side of the housing 16 is open. The housing 16 is in a cylindrical shape having a bottom capable of accommodating the lower end portion of the burner 14, the lower end portion of the ignition means 15, and the catalyst 12. The housing 16 includes a housing trunk portion 22 and a housing bottom plate portion 23. The housing trunk portion 22 is formed in a cylindrical shape. In this embodiment, the axial direction of the housing trunk portion 22 matches the vertical direction of the fuel processing system 11. The housing bottom plate portion 23 is a disk-shaped plate member for closing the opening at the lower end side of the housing trunk portion 22, and is fixed to and provided at the lower end of the housing trunk portion 22 by means of welding. The opening at the upper end side of the housing 16 is closed by the main chamber of reformer 17.

The main chamber of reformer 17 includes a catalyst 12 and a reforming container member 30.

The catalyst 12 is a catalyst for reforming.

The reforming container member 30 is a container accommodating the catalyst 12, and is accommodated in the housing 16. The reforming container member 30 includes an inner peripheral side wall surface portion 31, an external peripheral side wall surface portion 32, and a catalyst fixing unit 33.

The inner peripheral side wall surface portion 31 is formed from a member in a cylindrical shape.

The external peripheral side wall surface portion 32 is formed from a member in a cylindrical shape.

As described above, the catalyst 12 is provided in a gap between the inner peripheral side wall surface portion 31 and the external peripheral side wall surface portion 32.

The catalyst fixing unit 33 is a member limiting the movement of the catalyst in the vertical direction, and includes an upper end fixing unit 34 and a lower end fixing unit 35. The upper end fixing unit 34 and the lower end fixing unit 35 are annular-shaped plate members closing the gap between the inner peripheral side wall surface portion 31 and the external peripheral side wall surface portion 32.

The upper end fixing unit 34 is provided at the upper side of the catalyst 12 in the gap between the inner peripheral side wall surface portion 31 and the external peripheral side wall surface portion 32. The upper end fixing unit 34 is fixed to the inner peripheral side wall surface portion 31 by welding. A hole through which the reformer fuel can pass is formed in the upper end fixing unit 34.

The lower end fixing unit 35 is provided at the lower side of the catalyst 12 in the gap between the inner peripheral side wall surface portion 31 and the external peripheral side wall surface portion 32. The lower end fixing unit 35 is fixed to the inner peripheral side wall surface portion 31 by welding. A hole through which the reformer fuel can pass is formed in the lower end fixing unit 35.

A gap is formed between the lower end fixing unit 35 and the housing bottom plate portion 23.

A bottom portion partition portion 38 is provided at the lower end side of the inner peripheral side wall surface portion 31. The bottom portion partition portion 38 is a disk-shaped plate member for closing the opening of the lower end side of the inner peripheral side wall surface portion 31, and is fixed to and provided at the lower end of the inner peripheral side wall surface portion 31 by welding. A gap is formed between the bottom portion partition portion 38 and the housing bottom plate portion 23.

The burner chamber forming components 18 form a burner chamber 41 in which flames generated by the burner 14 and the ignition means 15 are accommodated, and are provided in the center of the housing 16. More specifically, the burner chamber forming components 18 are provided at the main chamber of reformer 17. The burner chamber forming components 18 are formed from members in a cylindrical shape, and are disposed in a concentric manner with respect to the housing trunk portion 22 of the housing 16. A gap is formed between the lower end of the burner chamber forming components 18 and the bottom portion partition portion 38.

As illustrated in FIG. 5, the reformer fuel supply tube 19 is a pipe for supplying the reformer fuel into the main chamber of reformer 17. One end portion of the reformer fuel supply tube 19 is connected to a catalyst reaction container for a previous step, not shown, and the other end portion thereof is connected to the upper end of the external peripheral side wall surface portion 32 of the main chamber of reformer 17, and in this embodiment, the other end portion thereof is connected to a portion higher than the upper end fixing unit 34.

The reformed gas outlet tube 20 is a pipe for discharging the reformed gas to the outside of the fuel processing system 11. The reformed gas outlet tube 20 is connected to around the upper end of the housing trunk portion 22, and the other end portion thereof is connected to a catalyst reaction container in a later step, not shown.

The combustion gas discharge tube 21 is a pipe for discharging a mixed gas of fuel gas and air combusted by the burner 14 and the stick shaped ignition means 15 performing ignition (hereinafter referred to as mixed gas) to the outside of the fuel processing system 11. One end portion of the combustion gas discharge tube 21 is connected to around the upper end of the inner peripheral side wall surface portion 31 of the main chamber of reformer 17, and the other end portion thereof is connected to a device and the like using exhaust gas, not shown.

### <Configuration of Burner>

As illustrated in FIG. 4, the burner 14 is formed with a fuel gas flow channel 51 for supplying the fuel gas of the mixed gas to the burner chamber 41 as illustrated in FIG. 5 and an air flow channel 52 for supplying the air of the mixed gas to the burner chamber 41. In this embodiment, the air flow channel 52 includes two paths, i.e., a first air flow channel 53 located at the external peripheral side of the fuel gas flow channel 51 and a second air flow channel 54 located at the inner peripheral side of the fuel gas flow channel 51.

The burner 14 includes a nozzle member 55, a nozzle fixing member 56 including an upstream side nozzle fixing unit 72 and a downstream side nozzle fixing unit 71, and a cover member 57.

As illustrated in FIG. 4, the nozzle member 55 is a cylindrical member formed with a first penetration hole 58 through which the ignition means 15 can penetrate. The nozzle member 55 includes an inner peripheral portion 59 located at the inner peripheral side, a center portion 60 located at the external peripheral side of the inner peripheral portion 59, and an external peripheral portion 61 located at the external peripheral side of the center portion 60. In the present embodiment, the upper end of the center portion 60 is located above the upper end of the external peripheral portion 61, and the upper end of the inner peripheral portion 59 is located above the upper end of the center portion 60, such that the three upper end portions form differences in level. The upper end of the center portion 60 of the nozzle member 55 and the upper end of the inner peripheral portion 59 are fixed to a downstream side nozzle fixing unit 71 of the nozzle fixing member 56 by welding. The upper end of the external peripheral portion 61 of the nozzle member 55 is fixed to the inner peripheral portion 92 of the cover member 57 by welding.

As illustrated in FIG. 4, the ignition means 15 is disposed in the first penetration hole 58 in a concentric manner to make a configuration in which a gap is provided between the nozzle member 55 and the ignition means 15. The gap between the nozzle member 55 and the ignition means 15 is the second air flow channel 54 explained later.

As illustrated in FIG. 1, a downstream side fuel gas flow channel constituting the downstream side of the fuel gas flow channel 51 is formed in the center portion 60 of the nozzle member 55. The downstream side fuel gas flow channel is a hole extending to a distal end side in the axial direction of the ignition means 15, i.e., a penetration hole extending in the vertical direction of the nozzle member 55.

The nozzle fixing member 56 serves as a base for fixing the nozzle member 55, and includes the downstream side nozzle fixing unit 71 and the upstream side nozzle fixing unit 72.

A second penetration hole 73 through which the nozzle member 55 can penetrate is formed in the center of the disk of the downstream side nozzle fixing unit 71.

The cover member 57 is configured to be provided with the cover member 57 at the lower side of the downstream side nozzle fixing unit 71.

The second penetration hole 73 is a hole extending toward the distal end side in the axial direction of the ignition means 15 explained later. More specifically, the second penetration hole 73 is a hole penetrating the vertical direction of the downstream side nozzle fixing unit 71.

The upper end portion of the inner peripheral portion 59 of the nozzle member 55 is provided in a middle portion opening portion 76 of the second penetration hole 73 of the downstream side nozzle fixing unit 71. The upper end portion of the inner peripheral portion 59 of the nozzle member 55 is fixed to the downstream side nozzle fixing unit 71 by welding.

The downstream side nozzle fixing unit 71 is formed on an upstream side fuel gas flow channel 512 at a portion of an external peripheral portion, for example, at the right side of the ignition means 15 in downstream side nozzle fixing unit 71 in FIG. 4. The upstream side fuel gas flow channel 512 is a flow channel through which the fuel gas flows, and diagonally extends from the upper portion of the external peripheral surface of the downstream side nozzle fixing unit 71 to the lower side of the inner peripheral surface. The upper end portion of the nozzle member 55 is provided in the second penetration hole 73 of the downstream side nozzle fixing unit 71, such that the downstream side of the upstream side fuel gas flow channel 512 is configured to be in communication with the upstream side of the nozzle member 55.

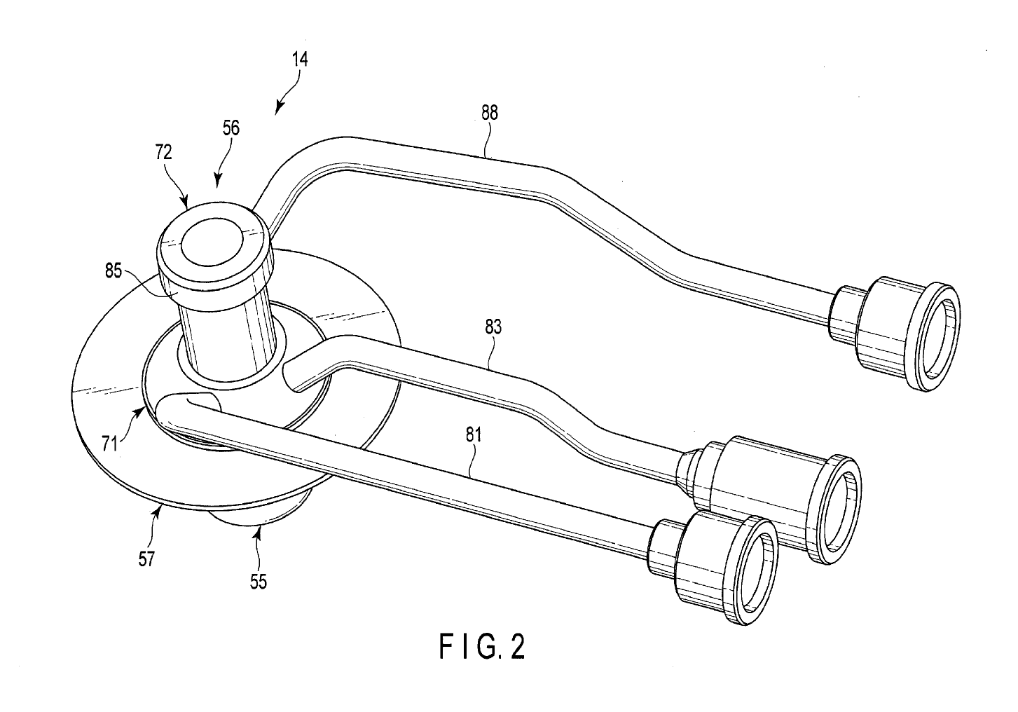

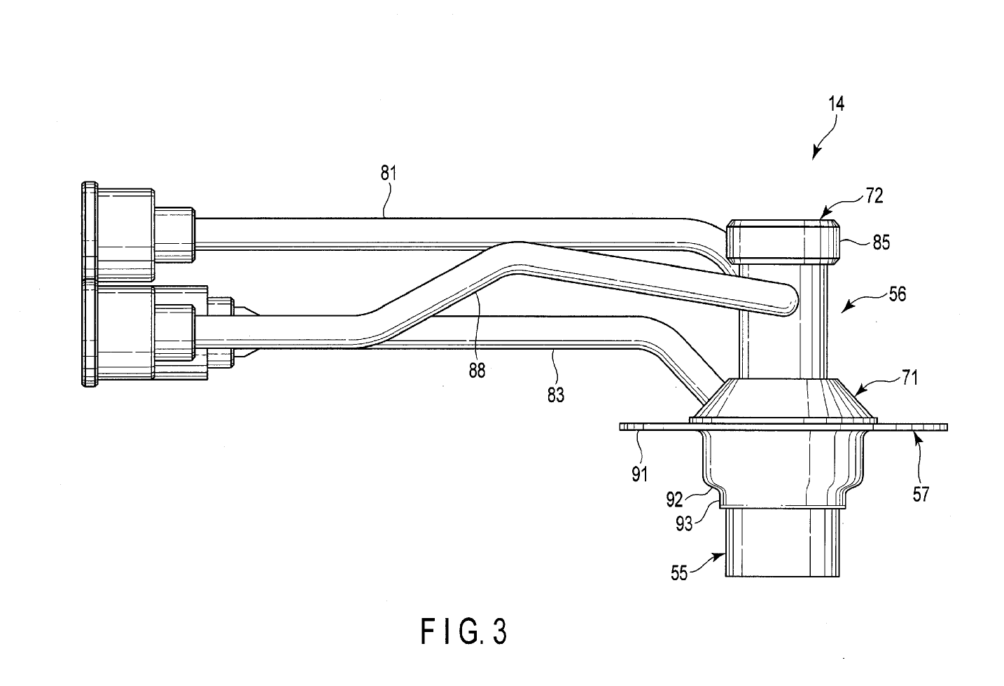

The opening portion at the upper end of the upstream side fuel gas flow channel 512 is connected to a fuel supply tube 81 as also illustrated in FIG. 2, FIG. 3. The fuel gas is configured to be provided from the outside to the fuel supply tube 81. The fuel gas may be, for example, a gas including hydrogen which is used by a fuel cell and which is not reacted in an electrode reaction among (so-called anode off gas) and a mixed gas of natural gas and air.

The downstream side nozzle fixing unit 71 is formed on a first upstream side air flow channel 532 at a portion of the external peripheral portion, for example, at the ignition means 15 in the downstream side nozzle fixing unit 71 and corresponding to the upstream side of the first air flow channel 53 in FIG. 4. The first upstream side air flow channel 532 is a flow channel through which the first air flows, and is a hole penetrating through the downstream side nozzle fixing unit 71 in the vertical direction. The downstream side of the first upstream side air flow channel 532 is configured to be in communication with the upstream side of the first downstream side air flow channel via an air chamber 82 explained later.

As also illustrated in FIG. 2, FIG. 3, the opening portion of the upper end of the first upstream side air flow channel 532 is connected to the first air supply tube 83. The first air is configured to be provided from the outside to the first air supply tube 83.

The upstream side nozzle fixing unit 72 forms a cylindrical shape, and as illustrated in FIG. 4, inside of the cylindrical shape, a third penetration hole 84 through which the ignition means 15 can penetrate is formed. The third penetration hole 84 is a hole penetrating through the upstream side nozzle fixing unit 72 in the vertical direction. The diameter of the third penetration hole 84 is formed to be larger than the diameter of the middle portion opening portion 76 of the second penetration hole 73. The lower end portion of the upstream side nozzle fixing unit 72 is fixed to and provided in the upper portion opening portion 75 of the second penetration hole 73 on the downstream side nozzle fixing unit 71 by welding, such that the third penetration hole 84 is coaxial with the second penetration hole 73. The third penetration hole 84 functions as a second upstream side air flow channel explained later.

The diameter at the upper end of the third penetration hole 84 of the upstream side nozzle fixing unit 72 is of a smaller diameter than the lower end. The upper end of the third penetration hole 84 is of such a size that the ignition means 15 is accommodated with the minimum gap, and the ignition means 15 is disposed to be coaxial with the third penetration hole 84.

An opening portion is formed at a portion of the external peripheral portion of the upstream side nozzle fixing unit 72, for example, at the left side of the upstream side nozzle fixing unit 72 in FIG. 4. A second air supply tube 88 is connected to the opening portion. The second air is configured to be provided from the outside to the second air supply tube 88.

The air chamber 82 is formed by the cover member 57 and the downstream side nozzle fixing unit 71, and the cover member 57 is a member for closing the opening portion at the center of the flange portion of the reformer unit 13. The cover member 57 is formed in a shape having a difference in level such that the external side in the diameter direction is higher. The cover member 57 according to this embodiment has a two-step structure, and includes an external peripheral portion 91 located at the external peripheral side and extending in the horizontal direction and an inner peripheral portion 92 located at a lower position at the inner peripheral side with respect to the external peripheral portion 91 and extending in the horizontal direction. A contact portion protruding to the lower side and coming into contact with around the upper end of the external periphery of the external peripheral portion 61 of the nozzle member 55 is formed at an edge portion of the inner peripheral side of the inner peripheral portion 92.

The cover member 57 is connected to the nozzle member 55 and the downstream side nozzle fixing unit 71 by welding at the inner peripheral portion 92 and the external peripheral portion 91, respectively.

### <Flow of Gas>

Like a conventional device, according to the fuel processing system 11 and the burner 14 having the above configuration, the fuel and the gas can be passed as follows.

First, the flows of the fuel and the gas provided to the reformer unit 13 will be explained.

As illustrated in FIG. 5, the reformer fuel provided from the supply source of the reformer fuel passes through the reformer fuel supply tube 19, and is provided to the gap above the upper end fixing unit 34 of the main chamber of reformer 17. Further, this reformer fuel passes through the hole of the upper end fixing unit 34 to be provided to the catalyst 12. When the reformer fuel comes into contact with the catalyst 12, the reformed gas is generated by the reforming reaction. The generated reformed gas passes through the hole of the lower end fixing unit 35, further passes through the gap between the housing 16 and the external peripheral side wall surface portion 32 of the main chamber of reformer 17, and it is discharged to the outside the fuel processing system 11 from the reformed gas outlet tube 20, and is collected.

In this case, in a case where a flame is generated by the burner 14 and the ignition means 15 in the reforming reaction, the reformer fuel is heated and kept at a high temperature by the heat of this flame. As a result, the reforming reaction advances stably.

Subsequently, the flow of the gas provided to the burner 14 will be explained.

First, as illustrated in FIG. 4, the fuel gas provided from the fuel supply tube 81 passes through the fuel gas flow channel 51, and more specifically the fuel gas provided from the fuel supply tube 81 passes through the upstream side fuel gas flow channel 512 of the downstream side nozzle fixing unit 71, the second penetration hole, and the fuel gas flow channel 51, and is provided to the burner chamber 41.

The first air provided from the first air supply tube 83 passes through the first air flow channel 53, and more specifically, the first air provided from the first air supply tube 83 passes through the first upstream side air flow channel 532 of the downstream side nozzle fixing unit 71, the air chamber 82, and the first air flow channel 53, and is provided to the burner chamber 41.

The second air provided from the second air supply tube 88 passes through the second air flow channel 54 and is provided to the burner chamber 41.

In this embodiment, the fuel gas is sandwiched by the first air and the second air and is provided to the burner chamber 41.

The mixed gas of the fuel gas and the air provided to the burner chamber 41 is ignited when a voltage is applied to the ignition means 15. Therefore, a flame is generated in the burner chamber 41, and the reformer fuel is kept at a high temperature as described above.

As illustrated in FIG. 5, a portion of the mixed gas provided to the burner chamber 41, for example, the combustion gas generated as a result of combustion of the mixed gas, passes through the gap between the burner chamber forming components 18 and the inner peripheral side wall surface portion 31 of the main chamber of reformer 17, and is discharged from the combustion gas discharge tube 21 to the outside of the fuel processing system 11.

### <Actions and Effects>

According to the present embodiment, as described above, the combustion device member according to the present invention can be configured in the reformer unit upper portion in the same manner as the conventional device, and the nozzle member 55 can be provided accurately at a predetermined position (concentric position) with respect to the downstream side nozzle fixing unit 71, and further, the ignition means 15 can be provided accurately at a predetermined position (concentric position) with respect to the downstream side nozzle fixing unit 71 by using the upstream side nozzle fixing unit 72.

Therefore, the burner 14 in which the nozzle member 55 can be disposed accurately at the predetermined position with respect to the nozzle fixing member 56 and the fuel processing system 11 having the burner 14 can be obtained.

Both of the nozzle member 55 and the nozzle fixing member 56 are made of a metal that can be welded, and welded to each other. Therefore, the nozzle member 55 can be easily fixed to the nozzle fixing member 56.

The first air flow channel 53 is provided at the external peripheral side of the fuel gas flow channel 51 of the nozzle member 55, and therefore, the first air flow channel 53 is configured to be disposed in a concentric manner with respect to the fuel gas flow channel 51. Therefore, the first air provided from the first air flow channel 53 to the burner chamber 41 is caused to be discharged to the outside of the fuel gas in the burner chamber 41, and the fuel gas is sandwiched between the first air and the second air provided from the second air flow channel 54, such that a preferable combustion can be ensured.

Since the air chamber 82 is formed in the downstream side nozzle fixing unit 71, the fuel gas provided from the first upstream side air flow channel 532 to the air chamber 82 can be provided to the first air flow channel 53 as uniformly as possible.

### Second Embodiment

The second embodiment will be explained with reference to FIG. 6. Substantially the same elements or elements achieving substantially the same actions and effects as the first embodiment are denoted with the same reference numerals, and explanations thereof are omitted. The materials of each member achieving substantially the same actions and effects are the same as those of the first embodiment.

In the second embodiment, the shape of the burner 111 is different from the shape of the burner 14 according to the first embodiment. More specifically, the burner 111 according to the second embodiment is made of the nozzle fixing member 112 and the nozzle member 113. The nozzle fixing member 112 corresponds to the nozzle fixing member 56 according to the first embodiment, and the nozzle member 113 corresponds to a shape obtained by integrating the upstream side nozzle fixing unit 72 and the nozzle member 55 according to the first embodiment.

In the second embodiment, the nozzle fixing member 112 corresponds to a downstream side nozzle fixing unit as described in the claims, and the nozzle member 113 corresponds to a nozzle member and an upstream side nozzle fixing unit as described in the claims. In FIG. 6, elements of the nozzle member 113 having the same structure or achieving the same actions and effects as the nozzle member 55 of the first embodiment are denoted with the same reference numerals as the first embodiment, and explanations thereof are omitted

The nozzle fixing member 112 forms a pillar shape overall, and the upstream side fuel gas flow channel 115 of the fuel gas flow channel 114 extends from the left side of nozzle fixing member 112 to the center in FIG. 6. The fuel chamber 78 is located at the downstream side of the upstream side fuel gas flow channel 115.

Further, in the nozzle fixing member 112, the first upstream side air flow channel 117 of the first air flow channel 116 extends from the right side of the nozzle fixing member 112 to the center in FIG. 6, and extends to the lower side on its way, such that an L shaped cross section is formed. The downstream side of the first upstream side air flow channel 117 is in communication with the air chamber 82.

In the second penetration hole 73 of the nozzle fixing member 112, the upper portion opening portion 75 (see FIG. 1) explained in the first embodiment is not formed, and the nozzle member 113 is configured to be fixed to the external peripheral surface of the middle portion opening portion 76 (see FIG. 1) by welding. The cover member 57 is fixed to and provided at the lower surface of the nozzle fixing member 112 by welding.

Subsequently, the flow of the gas provided to this burner 111 will be explained.

First, the fuel gas provided from the fuel supply tube 81 passes through the upstream side fuel gas flow channel 115 of the nozzle fixing member 112, the fuel chamber 78, and the fuel gas flow channel 114, and is provided to the burner chamber 41 as illustrated in FIG. 5.

The fresh air provided from the first air supply tube 83 passes through the first upstream side air flow channel 117 of the nozzle fixing member 112, the air chamber 82, and the first air flow channel 116, and is provided to the burner chamber 41 as illustrated in FIG. 5.

The second air provided from the second air supply tube 88 passes through the second upstream side air flow channel (third penetration hole 84) of the nozzle member 113 and the second air flow channel 54, and is provided to the burner chamber 41 as illustrated in FIG. 5.

Even when the shape of the burner 111 according to the second embodiment is used, the same effects and actions as those achieved when the burner 14 according to the first embodiment is used can be achieved.

Further, in the second embodiment, the nozzle fixing member 112 and the nozzle member 113 constituting the burner 111 are formed integrally, and therefore, the nozzle member 113 can be reliably disposed at a predetermined position with respect to the nozzle fixing member 112.

The present embodiment is not limited to the above, and can be made into various forms within the technical scope of the present invention.

Further, in the present embodiment, the metal members are fixed to each other by welding, but the metal members can also be fixed by brazing as necessary. However, when the metal members are fixed by welding, there is an advantage in that, even if the temperature of the combustion device becomes higher, leakage due to thermal stress is less likely to occur.

The housing trunk portion 22 of the reformer unit 13 of the fuel processing system 11 has a cylindrical shape in the explanation, but when the configuration of the present invention is considered, it is to be understood that, as long as it is a fuel processing system of a conventional internal combustion method, the burner according to the present invention can be incorporated even if it does not have a cylindrical shape.

### REFERENCE SIGNS LIST

11: fuel processing system
12: catalyst
14: burner
15: ignition means
16: housing
17: main chamber of reformer
18: burner chamber forming components
19: reformer fuel supply tube
20: reformed gas outlet tube
21: combustion gas discharge tube
22: housing trunk portion
23: housing bottom plate portion
30: reforming container member
31: inner peripheral side wall surface portion
32: external peripheral side wall surface portion
33: catalyst fixing unit
34: upper end fixing unit
35: lower end fixing unit
38: bottom portion partition portion
41: burner chamber
51: fuel gas flow channel
512: upstream side fuel gas flow channel
52: air flow channel
53: first air flow channel
532: first upstream side air flow channel
54: second air flow channel
55: nozzle member
56: nozzle fixing member
57: cover member
58: first penetration hole
59: inner peripheral portion
60: center portion
61: external peripheral portion
71: downstream side nozzle fixing unit
72: upstream side nozzle fixing unit
73: second penetration hole
75: upper portion opening portion
76: middle portion opening portion
78: fuel chamber
81: fuel supply tube
82: air chamber
83: first air supply tube
84: third penetration hole (second upstream side air flow channel)
88: second air supply tube
91: external peripheral portion
92: inner peripheral portion
111: burner
112: nozzle fixing member
113: nozzle member
114: fuel gas flow channel
115: upstream side fuel gas flow channel
116: first air flow channel
117: first upstream side air flow channel

What is claimed is:

1. A burner, which is provided with stick shaped ignition means disposed to penetrate through a part of the burner to ignite a mixed gas including air and fuel gas, and which is formed with an air flow channel in which the air flows and a fuel gas flow channel in which the fuel gas flows, the burner comprising:
a nozzle member formed with a first penetration hole through which the ignition means can penetrate, and formed on a downstream side of the air flow channel and a downstream side of the fuel gas flow channel;
a downstream side nozzle fixing unit which fixes the nozzle member and which is formed with a second penetration hole through which the nozzle member can penetrate and on an upstream side of the fuel gas flow channel, wherein the nozzle member is disposed in the second penetration hole such that the first penetration hole is coaxial with the second penetration hole; and
an upstream side nozzle fixing unit which fixes the nozzle member and which is formed with a third penetration hole through which the ignition means can penetrate and on an upstream side of the air flow channel, wherein the upstream side nozzle fixing unit is disposed on the downstream side nozzle fixing unit such that the third penetration hole is coaxial with the second penetration hole, and the ignition means disposed in the third penetration hole such that the ignition means is coaxial with the third penetration hole.

2. The burner according to claim 1, wherein any of the nozzle member, the downstream side nozzle fixing unit, and the upstream side nozzle fixing unit is made of a metal that can be welded, and the nozzle member, the downstream side nozzle fixing unit, and the upstream side nozzle fixing unit are integrated by welding.
